(19) United States
(12) Patent Application Publication
(10) Pub. No.: US 2015/0239472 A1
(43) Pub. Date: Aug. 27, 2015

(54) VEHICLE-INSTALLED OBSTACLE DETECTION APPARATUS HAVING FUNCTION FOR JUDGING MOTION CONDITION OF DETECTED OBJECT

(71) Applicant: DENSO CORPORATION, Kariya-City (JP)

(72) Inventors: TAKUMA SUDOU, Obu-shi (JP); JIN KURUMISAWA, Obu-shi (JP); TOYOHITO NOZAWA, Chita-gun (JP)

(21) Appl. No.: 14/627,263

(22) Filed: Feb. 20, 2015

(30) Foreign Application Priority Data
Feb. 21, 2014 (JP) 2014-031710

(51) Int. Cl. B60W 30/16; G01P 21/00

(52) U.S. Cl. CPC B60W 30/16; G01P 21/00; B60W 2550/10

(57) ABSTRACT

An obstacle detection apparatus in a host vehicle derives the value of absolute speed of a target object such as a preceding vehicle, and the distance of the object from the host vehicle, and compares the absolute speed with a threshold value that is increased in accordance with increase in value of a parameter which adversely affects the accuracy of deriving the absolute speed of the target object, such as the distance of the target object from the host vehicle or the running speed of the host vehicle. A judgement as to whether the target object is stationary or in motion is made based on results of the comparison.

### CROSS-REFERENCE TO RELATED APPLICATIONS

This application is based on and incorporates herein by reference Japanese Patent First Application No. 2014-31710 filed on Feb. 21, 2014.

### BACKGROUND OF THE INVENTION

1. Field of Application

The present invention relates to an obstacle detection apparatus for installation in a motor vehicle. In particular the invention relates to an obstacle detection apparatus having a function for judging whether a detected object, located ahead of the host vehicle of the apparatus, is stationary or is in motion.

2. Description of Related Art

Types of vehicle-installation apparatus are known for use in detecting objects (referred to in the following as target objects) that are located in a region ahead of the host vehicle of the apparatus and which are potential obstacles, and for judging whether any of the detected target objects is a preceding vehicle (i.e., another vehicle, which is running in front of the host vehicle, in the same travel path). It is known to use such an obstacle detection apparatus in a vehicle control system which controls the running speed of the host vehicle to follow such a preceding vehicle with a specific separation distance. In general, the target object detection is based on transmitting waves (e.g., millimeter-band radar waves, light waves, or sound waves) and analyzing signals obtained from received reflected waves.

A method has been proposed (for example in Japanese Patent Publication No. 2008-026030 referred to in the following as reference 1, in the case of a vehicle-installed obstacle detection apparatus employing a laser radar apparatus which transmits laser light waves, for use in a vehicle control system having a preceding vehicle following control function) for judging the motion condition of a detected target object based upon the difference between the running speed of the host vehicle of the obstacle detection apparatus and the relative speed of the target object with respect to the host vehicle, and upon the scattering of detected absolute positions of the target object.

With such a vehicle control system, different methods of controlling the speed of the host vehicle are applied in accordance with the motion condition of a target object. Hence, it is necessary to reliably determine whether the target object is in motion or is stationary.

It is known that a method such as that proposed in reference 1 can be used for judging the motion condition of a target object, whereby the judgement is based upon a record of successively detected positions of the target object and upon the result of comparing the absolute speed of the target object with a speed threshold value. However if the speed threshold value is not appropriate, then errors in the detection results obtained from a target object detection apparatus (e.g., radar apparatus) can result in erroneous judgement of the motion condition, in particular, an erroneous judgement that a target object is in motion when it is actually stationary.

It could be considered that such an erroneous judgement could be prevented by increasing the threshold value to a sufficient extent. However this presents the problem of an increased possibility of erroneous judgement that a target object is stationary, when it is actually moving at low speed.

### SUMMARY OF THE INVENTION

Hence it is desired to overcome the above problem, by providing an obstacle detection apparatus for installation on a host vehicle, which enables the motion condition of a target object to be reliably judged. In particular it is desired to provide an obstacle detection apparatus which can reliably prevent erroneous judgement that a target object is in motion when it is actually stationary, while also minimizing the probability of erroneous judgement that a target object is stationary when it is actually moving. This is achieved by taking into consideration the fact that the accuracy of estimating the absolute speed of the target object varies in accordance with specific factors, such as the distance of the target object from the host vehicle and the running speed of the host vehicle.

The invention is applicable to a host vehicle equipped with apparatuses operable for detecting respective distances from the host vehicle of target objects which are positioned ahead of the host vehicle, and the relative speed of a moving target object with respect to the host vehicle. The absolute speed of such a moving target object is calculated based on that relative speed and upon the running speed of the host vehicle (e.g., that running speed being calculated based on detecting the rotation speed of the host vehicle wheels).

The obstacle detection apparatus comprises a motion condition judgement section, which compares the calculated absolute value of speed of a detected target object with a motion judgement threshold value. A detected target object is judged to be a moving object when the absolute value of speed of the target object exceeds that threshold value, while otherwise, the target is object is judged to be a stationary object.

Designating a judgement-determining parameter as a parameter (such as the distance of the target object from the host vehicle or the running speed of the host vehicle) whereby a probability of error in the calculated absolute value of speed of the detected target object becomes increased in accordance with increasing value of the judgement-determining parameter, the motion condition judgement section is configured to set the motion judgement threshold value at a higher value, when the judgement-determining parameter is at a relatively high value, than when the judgement-determining parameter is at a relatively low value.

As a result, when there is a substantial possibility of a large amount of error in the calculated absolute value of speed of the detected target object (e.g., due to the respective motion conditions and relative positions of the host vehicle and the target object), motion judgement errors caused by an insufficiently high value of motion judgement threshold can be prevented. However in addition, when there is unlikely to be a large amount of error in the calculated absolute value of speed of the detected target object, motion judgement errors caused by an excessively high value of motion judgement threshold can be prevented.

Preferably, the motion judgement threshold value is varied in proportion to the judgement-determining parameter, within a specific range of values of the judgement-determining parameter.

The judgement-determining parameter may comprise the running speed of the host vehicle, or the distance from the host vehicle to the detected target object.

Alternatively, the running speed of the host vehicle and the distance from the host vehicle to the detected target object may be utilized as respective judgement-determining parameters. In that case, the motion condition judgement section can be configured to judge that the detected target object is a moving object when the calculated absolute value of speed of the detected target object exceeds both of a first motion judgement threshold value and a second motion judgement threshold value, and to otherwise judge that the target object is a stationary object, where the first motion judgement threshold value is determined in accordance with the running speed of the host vehicle and the second motion judgement threshold value is determined in accordance with the distance from the host vehicle to the detected target object.

As a further alternative, the motion condition judgement section can be configured to judge that the detected target object is a moving object when the calculated absolute value of speed of the detected target object exceeds at least one of the first motion judgement threshold value and second motion judgement threshold value, and to otherwise judge that the target object is a stationary object.

### BRIEF DESCRIPTION OF THE DRAWINGS

FIG. 1 is block diagram showing the general configuration of an embodiment of a vehicle control system which incorporates an obstacle detection apparatus according to the present invention;

FIG. 2 is a flow diagram for describing judgement processing executed by the embodiment with respect to a detected target object;

FIG. 3A is a graph for describing a relationship between speed threshold values and values of distance of a target object from a host vehicle, and FIG. 3B is a graph for describing a relationship between speed threshold values and values of running speed of the host vehicle, as utilized by the embodiment; and

FIGS. 4A and 4B are graphs for use in describing problems which arise from utilizing a fixed speed threshold value.

### DESCRIPTION OF PREFERRED EMBODIMENTS

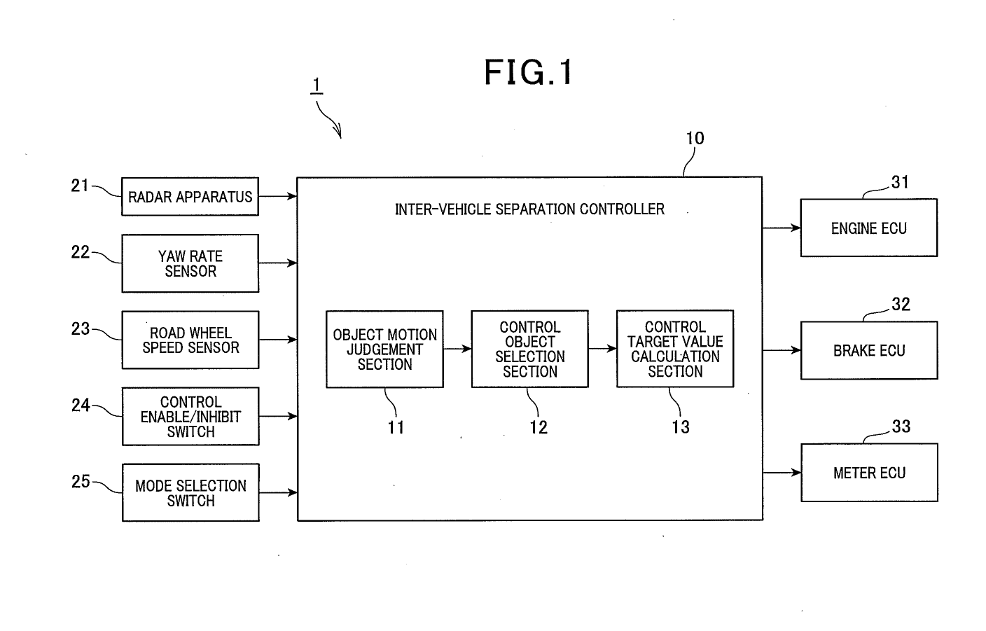

The vehicle control apparatus 1 shown in FIG. 1 is installed on a motor vehicle, referred to in the following as the host vehicle, and serves to detect the positions, directions (relative to the heading direction of the host vehicle) and speeds of objects (target objects) which are located ahead of the host vehicle. The vehicle control apparatus 1 also serves to recognize a target object which is a preceding vehicle (i.e., is a vehicle which is positioned directly ahead of the host vehicle, in the same travel path), and to control the speed of the host vehicle to follow a preceding vehicle. In particular (as a function of the incorporated obstacle detection apparatus), the vehicle control apparatus 1 judges the motion condition of a detected target object such as a preceding vehicle i.e., judges whether the target object is stationary or is in motion.

As shown in FIG. 1, the vehicle control apparatus 1 is based on an inter-vehicle separation controller 10, which includes a CPU (central processing unit), input/output interface, data storage media such as ROM and RAM, drive circuits, detection circuits, etc. The CPU of the inter-vehicle separation controller 10 executes a program which has been stored beforehand in the data storage media, to implement respective functions of a object motion judgement section 11, a control object selection section 12 and a control target value calculation section 13 which are described hereinafter. The hardware configuration of the inter-vehicle separation controller 10 can be of a generally known type, so that detailed description is omitted.

The inter-vehicle separation controller 10 receives a detection signal expressing the yaw rate of the host vehicle from a yaw rate sensor 22, and a detection signal expressing the rotation speed of the road wheels of the host vehicle from a road wheel speed sensor 23. The inter-vehicle separation controller 10 also receives a control enable/inhibit signal from a control enable/inhibit switch 24 and a mode selection signal from a mode selection switch 25.

The radar apparatus 21 transmits waves such as millimeter-band electromagnetic waves into a region in front of the host vehicle, for detecting any target objects and for deriving the distance from the host vehicle to a detected target object, the relative speed of the target object with respect to the host vehicle, etc., based on received reflected waves from the target object. The radar apparatus 21 is not restricted to any specific type of object detection apparatus, so that detailed description is omitted.

The yaw rate sensor 22 detects the yaw rate of the host vehicle, and outputs a corresponding detection signal. The road wheel speed sensor 23 utilizes a sensor which detects the rotation speed of the road wheels of the host vehicle (i.e., which is correlated with the running speed of the vehicle), and outputs a corresponding detection signal. The inter-vehicle separation controller 10 uses the detection signal from the road wheel speed sensor 23 to derive the running speed of the host vehicle, and in various calculation processing. The yaw rate sensor 22 and the road wheel speed sensor 23 can be of generally known configuration, so that detailed description is omitted.

The switches 24 and 25 are respectively operable by the driver of the host vehicle, with the enable/inhibit signal from the control enable/inhibit switch 24 designating whether or not a control mode (currently specified by the mode selection signal from the mode selection switch 25, selected from one of a plurality of control modes) is to be applied. The control modes of this embodiment include a mode in which the running speed of the host vehicle is controlled to follow a preceding vehicle.

The object motion judgement section 11 executes processing (for each of one or more target objects that are currently detected by the radar apparatus 21) to judge whether the target object is a stationary object or a moving object. Details of the processing are described hereinafter.

Based on the results obtained by the object motion judgement section 11, the control object selection section 12 executes processing for selecting a detected moving object which is a preceding vehicle. The control target value calculation section 13 calculates a control target value of acceleration for the host vehicle, as an acceleration value required for following a preceding vehicle which has been selected by the control object selection section 12, and generates control signals expressing a control target value of acceleration, which are supplied to the engine ECU 31 and the brake ECU 32 from the inter-vehicle separation controller 10. The control target value of acceleration has a positive or a negative value, in accordance with acceleration or deceleration being required.

The inter-vehicle separation controller 10 also supplies a signal expressing the selected control mode condition, and the control objects (for example, information concerning a selected preceding vehicle) to the meter ECU 33.

The engine ECU 31 controls the acceleration of the host vehicle, by determining the output power produced by the engine based on the control target value of acceleration. Braking of the host vehicle is similarly controlled based on the control target value of acceleration, by the brake ECU 32 and by the engine ECU 31.

The meter ECU 33 controls displaying of information by display devices of the instrument panel, etc., of the host vehicle, based on signals expressing the control mode condition and on information concerning a control target object.

Control executed by the vehicle control apparatus 1 is described more specifically in the following. Firstly, operations relating to vehicle following control in general are described. Motion condition judgement processing is then described, for determining whether a target object which has been judged to be a preceding vehicle is stationary or in motion.

While operating power is being supplied to the vehicle control apparatus 1, detection signals produced from sensors including the radar apparatus 21 and the yaw rate sensor 22 are inputted to the inter-vehicle separation controller 10, together with signals which are outputted from the control enable/inhibit switch 24 and the mode selection switch 25.

The control object selection section 12 executes processing based on the inputted detection signals for calculating respective values of host vehicle path probability for each of one or more detected target objects which have been judged to be moving objects. The host vehicle path probability is the probability that the target object is positioned ahead (i.e., without interposition of another target object) of the host vehicle, in the same travel path (same traffic lane) as the host vehicle.

The running speed of the host vehicle is calculated by the control object selection section 12 based on the wheel rotation speed detection signal from the road wheel speed sensor 23. The curvature of the travel path of the host vehicle is calculated based on that value of running speed, and on the yaw rate of the host vehicle as expressed by the detection signal from the yaw rate sensor 22. In addition, the control object selection section 12 executes processing for calculating the position of the target object relative to the host vehicle based on signals inputted from the radar apparatus 21 which express the relative direction (measured as an angle with respect to the forward direction of the host vehicle) and distance of the target object with respect to the host vehicle. The host vehicle path probability for the target object is then calculated based on the position of the target object and the curvature of the travel path. Methods of deriving such a host vehicle path probability are known in the prior art, so that detailed description is omitted herein.

The control target value calculation section 13 performs judgement processing for judging whether a target object is a preceding vehicle (i.e., is another vehicle which is located directly ahead of the host vehicle, running in the same travel path). The judgement is performed based on whether the host vehicle path probability obtained for the target object by the control object selection section 12 exceeds a predetermined threshold value. If the target object is selected as a preceding vehicle, the control target value calculation section 13 executes processing for calculating a target acceleration value (i.e., positive or negative value) as required for the host vehicle to maintain a predetermined required separation distance from the preceding vehicle. The types of processing executed by the control object selection section 12 and the control target value calculation section 13 and are known in the prior art, so that detailed description is omitted herein.

When the control target value calculation section 13 derives the target acceleration value, corresponding control signals are outputted to the engine ECU 31 and the brake ECU 32, for accelerating/decelerating the host vehicle at the target value. For example if the separation distance between the preceding vehicle and the host vehicle exceeds the predetermined distance, a positive value of target acceleration is derived, causing the engine ECU 31 to increase the output power of the engine. The running speed of the host vehicle is thereby increased, so that the separation distance is reduced appropriately.

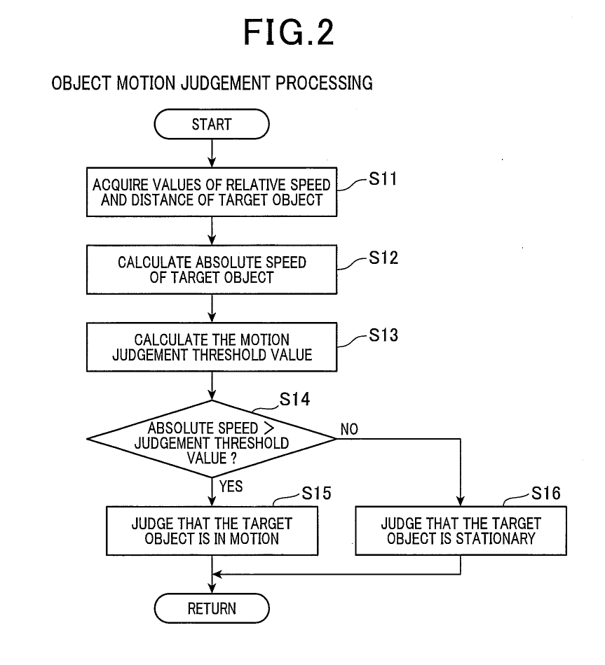

The processing executed by the object motion judgement section 11 of this embodiment (referred to in the following as object motion judgement processing) for judging whether a target object is stationary or in motion, which is a particular feature of the present invention, is described in the following referring to the flow diagram of FIG. 2.

When the detection signals produced from the radar apparatus 21 and inputted to the inter-vehicle separation controller 10 express one or more detected target objects, the mobile object judgement processing shown in FIG. 2 is executed with respect to each of the detected target objects, for judging whether the target object is stationary or in motion. Specifically, based on the detection signal acquired from the radar apparatus 21, the object motion judgement section 11 first calculates the relative speed of the target object with respect to the host vehicle and the distance between the target object and the host vehicle (step S11).

Next, the detection signal from the road wheel speed sensor 23 is acquired, and the running speed of the host vehicle is calculated based on the value of wheel rotation speed expressed by that detection signal. The absolute speed of the target object is then calculated (step S12), based on the relative speed value obtained in step S11 and on the running speed of the host vehicle.

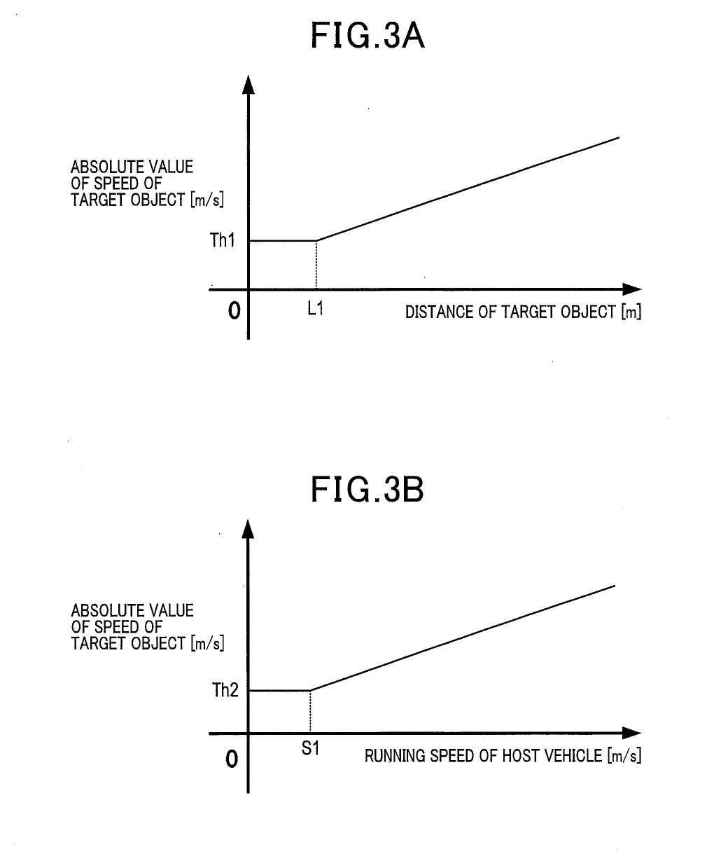

The object motion judgement section 11 then executes processing to obtain motion judgement threshold values (step S13). With this embodiment, two motion judgement threshold values are obtained, determined in accordance with respectively different parameters (referred to in the following as the judgement-determining parameters), with the threshold values having respective variation characteristics illustrated by the graphs of FIGS. 3A and 3B. The judgement threshold value illustrated in FIG. 3A is determined in accordance with the distance (m) between the host vehicle and the target object, and is referred to in the following as the distance-related judgement threshold value (i.e., having the target object distance as the corresponding judgement-determining parameter). The judgement threshold value illustrated in FIG. 3B is determined in accordance with the running speed (m/s) of the host vehicle, and is referred to in the following as the host speed-related judgement threshold value (i.e., having the host vehicle running speed as the corresponding judgement-determining parameter).

In the case of the distance-related judgement threshold value as shown in FIG. 3A, this takes a fixed value Th1 (m/s) for values of distance between the host vehicle and target object that are within the range 0 to L1 (m). As the distance between the host vehicle and target object increases above L1 (m), the distance-related judgement threshold value increases proportionally (with this example, in linear proportion).

In the case of the host speed-related judgement threshold value as shown in FIG. 3B, this takes a fixed value Th2 (m/s) for values of running speed of the host vehicle that are within the range 0 to S1 (m/s). As the running speed of the host vehicle increases above S1 (m/s), the host speed-related judgement threshold value increases proportionally (with this example, in linear proportion).

Based on the detection signals from the radar apparatus 21, the object motion judgement section 11 executes processing for obtaining the distance-related judgement threshold value corresponding to the distance to the target object, and based on the running speed of the host vehicle (as derived from the detection signal of the road wheel speed sensor 23) the object motion judgement section 11 executes processing for obtaining the host speed-related judgement threshold value corresponding to that value of running speed.

The object motion judgement section 11 may be configured to obtain the distance-related judgement threshold value and the host speed-related judgement threshold value by table look-up operations, i.e., by referring to stored data tables corresponding to the graphs of FIGS. 3A and 3B. Alternatively, the object motion judgement section 11 may be configured to obtain the distance-related judgement threshold value and the host speed-related judgement threshold value by executing calculation processing corresponding to the graphs of FIGS. 3A and 3B.

When the distance-related judgement threshold value and the host speed-related judgement threshold value have been obtained, the object motion judgement section 11 then (step S14) executes processing for comparing the absolute speed value obtained in step S12 with each of these threshold values. Specifically, a decision is made as to whether the absolute speed value of the target object exceeds the distance-related judgement threshold value and also the host speed-related judgement threshold value. If both of these threshold values are exceeded (YES decision), the object motion judgement section 11 judges (step S15) that the target object is in motion, while otherwise (NO decision), it is judged (step S16) that the target object is stationary.

With the present embodiment, a target object is judged to be in motion if the absolute speed value of the target object exceeds both the distance-related judgement threshold value and also the host speed-related judgement threshold value. However it would be alternatively possible to configure the object motion judgement section 11 to judge that the target object is in motion (step S15 executed) when the absolute speed value of the target object exceeds either or both of the distance-related judgement threshold value and the host speed-related judgement threshold value.

Furthermore it would be possible for the apparatus to utilize only the distance-related judgement threshold value, or to utilize only the host speed-related judgement threshold value.

The basis for adjusting the judgement threshold values as described above is as follows. When a target object is relatively distant from the host vehicle, it can be expected that there will be an increased probability of error, and greater magnitude of error, in the value of relative speed which is calculated for a target object, by comparison with the case in which the target object is closer to the host vehicle. The error in the derived value of relative speed will result in an error in the absolute speed value which is calculated for the target object. That error in the absolute speed value may result in an object being erroneously judged to be in motion, when it is actually stationary. With this embodiment, such an error is substantially eliminated, by increasing the motion judgement threshold value in accordance with increasing distance of the target object.

However when there is only a short separation distance between the target object and the host vehicle, so that the absolute speed of the target object can be accurately estimated, the motion judgement threshold value is set at a low value, thereby reducing the probability that a stationary object may be erroneously detected as a moving object.

Similarly when the running speed of the host vehicle is relatively high, it can be expected that there will be a greater probability and magnitude of error in the value of running speed that is calculated based on the detection signal from the road wheel speed sensor 23, by comparison with the case in which the running speed of the host vehicle is relatively low. In this case too, the error in the calculated value of running speed of the host vehicle will result in an error in the absolute speed value which is calculated for the target object, so that a target object may be erroneously judged to be in motion, when it is actually stationary. In this case too, such an error is substantially eliminated by increasing the motion judgement threshold value in accordance with increasing running speed of the host vehicle.

However when the host vehicle is running at a low speed, so that the absolute speed of the target object can be accurately estimated, the motion judgement threshold value is set at a low value, thereby reducing the probability that a stationary object may be erroneously detected as a moving object.

As can be understood from the above, with the present embodiment, a decision is made as to whether a detected target object is in motion or is stationary, in accordance with whether or not the estimated absolute speed of the target object exceeds both of respective motion judgement threshold values, i.e., the distance-related judgement threshold value and the host speed-related judgement threshold value. Each of these threshold values is increased, within a range of values of the corresponding judgement-determining parameter (as defined hereinabove) in which there is an increased probability of error in the parameter value (i.e., error which will result in error in the calculated value of absolute speed of a target object), by comparison with a range of values of the judgement-determining parameter in which a relatively small probability of error is to be expected.

More specifically, with the present embodiment as shown in FIGS. 3A and 3B, each motion judgement threshold value is held fixed within a range of small values of the corresponding judgement-determining parameter and, above that range, increases in proportion to increase of the corresponding judgement-determining parameter value.

Thus with the example of FIG. 3A, the distance-related judgement threshold value is held fixed (at a low value) with respect to changes in the estimated distance of a detected target object within the range from 0 to L1 (m), i.e., a range in which the probability of error occurrence, and amount of error, in the distance of a target object as detected by the radar apparatus 21 can be expected to be small. For distance values exceeding L1 (m), in which the probability and magnitude of target object distance detection errors can be expected to increase, the distance-related judgement threshold value increases linearly in accordance with increase of the detected target object distance.

Similarly with the example of FIG. 3B, the host speed-related judgement threshold value is held fixed (at a low value) with respect to changes in the calculated running speed of the host vehicle within the range from 0 to S1 (m/s), i.e., a range in which the probability and magnitude of error in the value of running speed (calculated based on the detection signal from the road wheel speed sensor 23) can be expected to be small. For values of running speed exceeding S1 (m/s), i.e., a range in which the probability and amount of error in the calculated value of host vehicle running speed can be expected to increase, the host speed-related judgement threshold value increases linearly in accordance with increase of the calculated value of running speed of the host vehicle.

A motion judgement error whereby a stationary target object is incorrectly judged to be in motion, occurring when the target object is relatively distant and/or the host vehicle is running at a relatively high speed, can thereby be effectively prevented. However the embodiment enables a high accuracy of judging whether a target object is moving or stationary, under a condition whereby the target object is relatively close and the running speed of the host vehicle is relatively low.

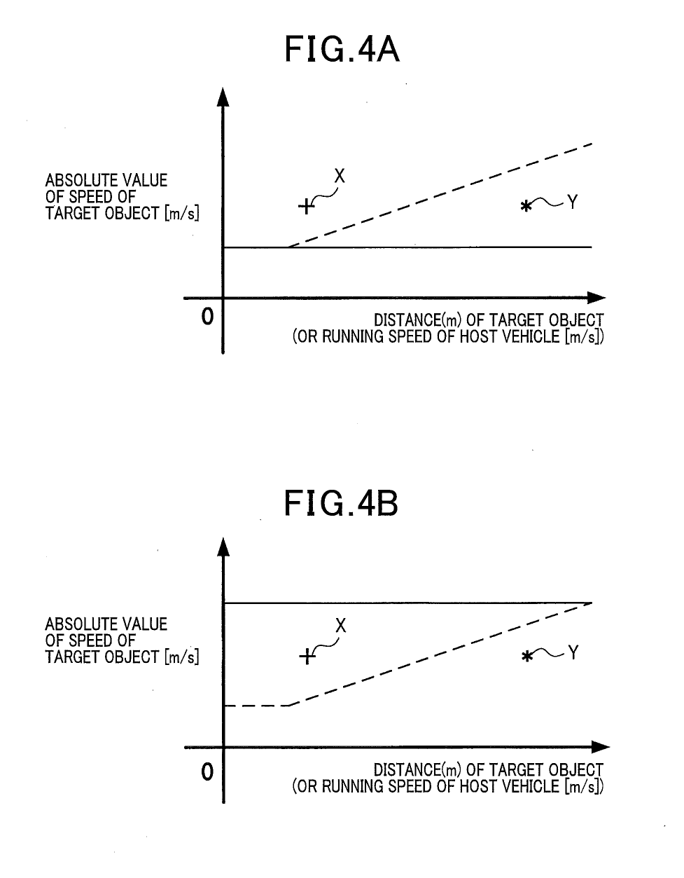

FIGS. 4A and 4B are graphs for illustrating the effects of using a fixed motion judgement threshold value for judging the motion condition of a target object, as opposed to using the threshold value characteristics of the above embodiment as illustrated in FIGS. 3A, 3B. In FIGS. 4A and 4B, the cross symbol X indicates the estimated value of absolute speed (obtained as described above) of a target object which is actually in motion, and is located at a short distance ahead of the host vehicle, while the host vehicle is moving at low speed. The asterisk symbol Y indicates the estimated value of absolute speed of a target object which is actually stationary, when the target object is located is at a substantial distance ahead of the host vehicle and/or the host vehicle is moving at a relatively high speed. The broken-line portions shown in FIGS. 4A, 4B correspond to the motion judgement threshold value variation characteristics of the present invention, described above referring to FIGS. 3A, 3B.

As shown by FIG. 4A, if the motion judgement threshold value were to be held fixed at a low value (i.e., a value which is appropriate when the target object is close to the host vehicle and the host vehicle is moving slowly), the motion condition (stationary) of the target object corresponding to the X symbol will be correctly judged. However it will be erroneously judged that the target object corresponding to the Y symbol is in motion. With the above embodiment, by appropriately increasing the judgement threshold value in accordance with increase of the distance of the target object and of the running speed of the host vehicle, it is ensured that the estimated absolute speed of the target object corresponding to the Y symbol will be below the motion judgement threshold value, so that it will be correctly judged that the target object is stationary.

In the example of FIG. 4B, the judgement threshold value is held fixed at a high value (i.e., a value sufficient to prevent the judgement error described above with respect to the Y symbol in FIG. 4A). In that case, it will be erroneously judged that the target object corresponding to the X symbol is stationary (since its estimated absolute speed is below the motion judgement threshold value) when it is actually in motion. With the above embodiment however, it is ensured that the estimated absolute speed of the target object corresponding to the X symbol will be above the motion judgement threshold value, so that it will be correctly judged that the target object is in motion.

The above embodiment has been described for the case in which a millimeter-band radar apparatus is utilized for estimating the relative distances and angular directions of respective detected target objects in relation to the host vehicle. However the invention is not limited to any specific type of detection apparatus, and it would be equally possible to utilize a sonar type of detection apparatus, etc., or to utilize a camera apparatus which captures images of a region ahead of the host vehicle and to estimate the relative distances and directions of target objects with respect to the host vehicle based on contents of the captured images.

It should thus be understood that various modifications and alternative forms of the above embodiment may be envisaged, which fall within the scope claimed for the invention as set out in the appended claims.

In the appended claims, a motion condition judgement section is exemplified by the object motion judgement section of the above embodiment. A judgement-determining parameter is exemplified by the distance of target object (FIG. 3A of the embodiment) and by the running speed of host vehicle (FIG. 3B of the embodiment).

What is claimed is:

1. A vehicle-use obstacle detection apparatus for installation on a host vehicle, the host vehicle being equipped with a target object detection section and a speed detection section, the target object detection section being configured for detecting a target object located in a region ahead of the host vehicle and for deriving a value of distance of the detected target object from the host vehicle and a value of relative speed of the detected target object with respect to the host vehicle, the speed detection section being configured for deriving a value of running speed of the host vehicle,
the obstacle detection apparatus comprising a motion condition judgement section configured for calculating an absolute value of speed of the detected target object based on the derived values of relative speed of the detected target object and running speed of the host vehicle, for comparing the calculated absolute value of speed of the detected target object with a motion judgement threshold value, for judging that the detected target object is a moving object when the calculated absolute value of speed of the detected target object exceeds the motion judgement threshold value, and for otherwise judging that the detected to be is s stationary object;
wherein designating a judgement-determining parameter as a parameter whereby a probability of error in the calculated absolute value of speed of the detected target object becomes increased in accordance with increasing value of the judgement-determining parameter, the motion condition judgement section is configured to set the motion judgement threshold value at a higher value, when the judgement-determining parameter is at a relatively high value, than when the judgement-determining parameter is at a relatively low value.

2. The obstacle detection apparatus as claimed in claim 1, wherein the motion judgement threshold value is varied in proportion to the judgement-determining parameter, within a specific range of values of the judgement-determining parameter.

3. The obstacle detection apparatus as claimed in claim 1, wherein the judgement-determining parameter comprises the running speed of the host vehicle.

4. The obstacle detection apparatus as claimed in claim 1, wherein the judgement-determining parameter comprises the distance from the host vehicle to the detected target object.

5. The obstacle detection apparatus as claimed in claim 1, wherein the running speed of the host vehicle and the distance from the host vehicle to the detected target object constitute respective judgement-determining parameters.

6. The obstacle detection apparatus as claimed in claim 5, wherein the motion condition judgement section is configured to judge that the detected target object is a moving object when the calculated absolute value of speed of the detected target object exceeds both of a first motion judgement threshold value and a second motion judgement threshold value, the first motion judgement threshold values being determined in accordance with the running speed of the host vehicle and the second motion judgement threshold value being determined in accordance with the distance from the host vehicle to the detected target object.

7. The obstacle detection apparatus as claimed in claim 5, wherein the motion condition judgement section is configured to judge that the detected target object is a moving object when the calculated absolute value of speed of the detected target object exceeds at least one of a first motion judgement threshold value and a second motion judgement threshold value, the first motion judgement threshold values being determined in accordance with the running speed of the host vehicle and the second motion judgement threshold value being determined in accordance with the distance from the host vehicle to the detected target object.

8. The obstacle detection apparatus as claimed in claim 1, wherein the motion condition judgement section is configured to set the motion judgement threshold value at a fixed relatively low value when the judgement-determining parameter is within a specific range of low values extending from a value of zero, and to successively increase the motion judgement threshold value in accordance with increase of the judgement-determining parameter value above the specific range of low values.
